(19) United States
(12) Patent Application Publication
(10) Pub. No.: US 2025/0178114 A1
(43) Pub. Date: Jun. 5, 2025

(54) ARC WELDING DEVICE

(71) Applicant: HITACHI ASTEMO, LTD., Hitachinaka-shi, Ibaraki (JP)

(72) Inventors: Takahiro MORI, Hitachinaka-shi, Ibaraki (JP); Masaaki SUZUKI, Hitachinaka-shi, Ibaraki (JP); Toru KATO, Hitachinaka-shi, Ibaraki (JP); Toshio HORI, Hitachinaka-shi, Ibaraki (JP)

(73) Assignee: HITACHI ASTEMO, LTD., Hitachinaka-shi, Ibaraki (JP)

(21) Appl. No.: 18/842,442

(22) PCT Filed: Jun. 30, 2022
(86) PCT No.: PCT/JP2022/026280

§ 371 Date: Aug. 29, 2024

(51) Int. Cl. B23K 9/28; B23K 9/12

(52) U.S. Cl. CPC B23K 9/28; B23K 9/125

(57) ABSTRACT

Provided is an arc welding device capable of welding base materials different in plate thickness, shape, or the like from each other with high quality in a narrow work space. An arc welding device 1 welds a first base material 80 and a second base material 90 that respectively include flat parts 81 and 91, and bent parts 82 and 92, the flat parts 81 and 91 extending in a direction of approaching each other, and the bent parts 82 and 92 being bent from the flat parts 81 and 91 and extending in an intersecting direction of the flat parts 81 and 91 to be in contact with each other, the arc welding device including: a welding electrode 11; a first ground electrode 20 extending along the bent part 82 of the first base material 80 to be in contact with the flat part 81 of the first base material 80; and a second ground electrode 30 extending along the bent part 92 of the second base material 90 to be in contact with the flat part 91 of the second base material 90, the first ground electrode 20 and the second ground electrode 30 being respectively in contact with the flat part 81 of the first base material 80 and the flat part 91 of the second base material 90 independently of each other.

### TECHNICAL FIELD

The present invention relates to an arc welding device.

### BACKGROUND ART

A power converter includes a power module with a terminal that is joined to a bus bar by arc welding in many cases. The power converter downsized and reduced in height causes a work space for welding the terminal and the bus bar to be narrowed. The work space having been narrowed is likely to cause interference with peripheral components, so that the terminal and the bus bar are difficult to be grounded using a chuck mechanism that clamps and fixes the terminal and the bus bar. Thus, the work space having been narrowed causes a difficulty in ensuring necessary welding quality.

PTL 1 discloses a welding device including: a nozzle formed in a shape of a bottomed tubular body having an opening; and a welding heat source accommodated and disposed inside the nozzle, in which the opening of the nozzle includes a peripheral edge part that is brought into contact with a joint body to weld the joint body while the welding heat source generates spattering.

### CITATION LIST

### Patent Literature

PTL 1: JP 2015-193019 A

### SUMMARY OF INVENTION

### Technical Problem

The power converter downsized and reduced in height includes the terminal of the power module and the bus bar that may be different in plate thickness, shape, or the like from each other in a joint therebetween. The welding device disclosed in PTL 1 does not consider a case where the terminal of the power module and the bus bar are different in plate thickness, shape, or the like from each other, and thus may be difficult to ensure necessary welding quality. Such a problem occurs not only in the power converter but also in a device required to weld base materials different in plate thickness or shape from each other in a narrow work space.

The present invention is made in view of the above, and it is an object of the present invention to provide an arc welding device capable of welding base materials different in plate thickness, shape, or the like from each other with high quality in a small work space.

### Solution to Problem

To solve the above problem, an arc welding device of the present invention welds a first base material and a second base material that respectively include flat parts and bent parts, the flat parts extending in a direction of approaching each other, and the bent parts being bent from the corresponding flat parts and extending in an intersecting direction of the flat parts to be in contact with each other, the arc welding device including: a welding electrode disposed facing a contact part between the bent part of the first base material and the bent part of the second base material; a first ground electrode extending along the bent part of the first base material to be in contact with the flat part of the first base material; and a second ground electrode extending along the bent part of the second base material to be in contact with the flat part of the second base material, the first ground electrode and the second ground electrode being respectively in contact with the flat part of the first base material and the flat part of the second base material independently of each other.

### Advantageous Effects of Invention

The present invention enables providing an arc welding device capable of welding base materials different in plate thickness, shape, or the like from each other with high quality in a narrow work space.

Problems, configurations, and effects other than the above will be clarified by the following description of embodiments.

### BRIEF DESCRIPTION OF DRAWINGS

FIG. 1 is an exploded perspective view of a power converter including a welding target of an arc welding device according to the present embodiment.

FIG. 2 is an enlarged view of a main part of a section taken along line A-A illustrated in FIG. 1.

FIG. 3 is a schematic diagram illustrating a configuration of the arc welding device of the present embodiment.

FIG. 4 is a schematic sectional diagram taken along line B-B illustrated in FIG. 3.

FIG. 5 is a diagram for illustrating another example of a first ground electrode different in shape from that in FIG. 4.

FIG. 6 is a diagram for illustrating operation of a load adjustment mechanism when a first base material and a second base material are identical in shape.

FIG. 7 is a diagram for illustrating operation of the load adjustment mechanism when the first base material and the second base material are different in shape.

FIG. 8 is a diagram for illustrating operation of the load adjustment mechanism when the first base material and the second base material are different in shape.

### DESCRIPTION OF EMBODIMENTS

Hereinafter, embodiments of the present invention will be described with reference to the drawings. Configurations denoted by the same reference numerals in each embodiment have similar functions in each embodiment unless otherwise specified, and the description thereof will not be duplicated.

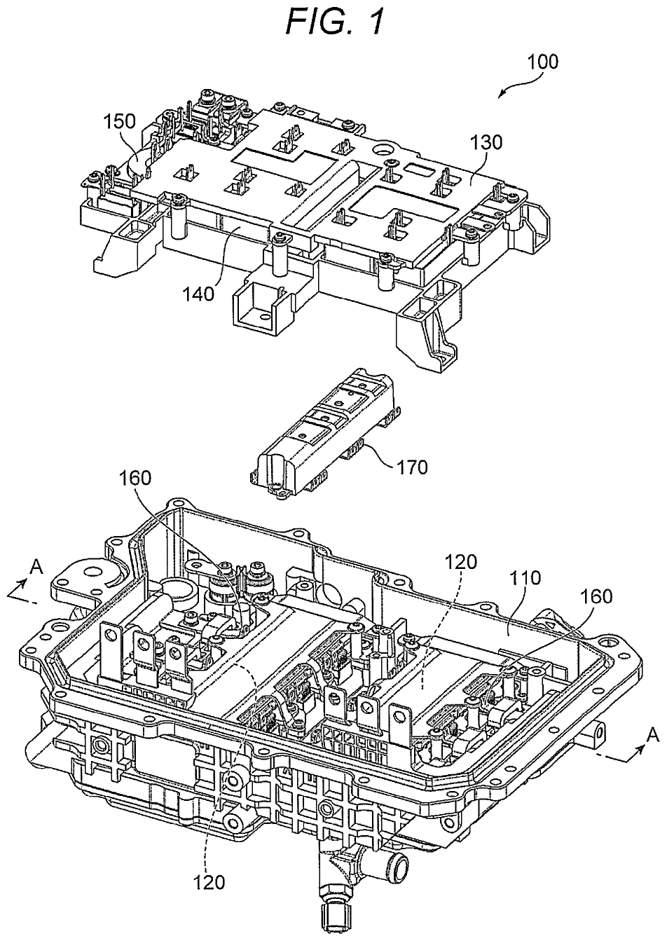

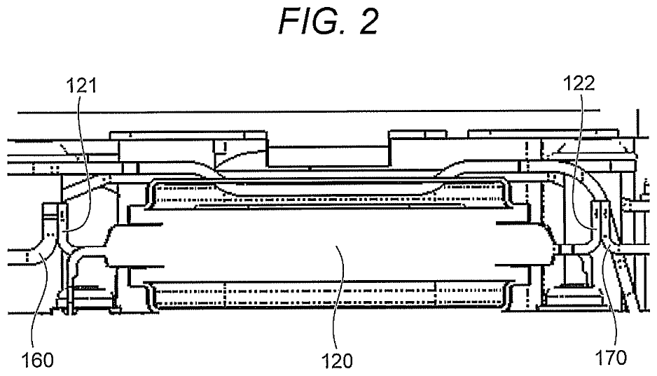

FIG. 1 is an exploded perspective view of a power converter 100 including a welding target of an arc welding device 1 according to the present embodiment. FIG. 2 is an enlarged view of a main part of a section taken along line A-A illustrated in FIG. 1.

The power converter 100 includes a housing 110, a power module 120 including a semiconductor device and performing power conversion, and a connector and a bus bar electrically connected to the semiconductor device of the power module 120. The power converter 100 further includes electronic components such as a mold bus bar 130, a capacitor 140, and a noise filter circuit 150 that are disposed in the housing 110 and electrically connected to the power module 120.

The power converter 100 illustrated in FIG. 1 is a dual type that controls input and output of two motors, and in which two power modules 120 are provided in parallel. However, the power converter 100 is not limited to the dual type illustrated in FIG. 1.

The power module 120 includes a semiconductor device that converts DC power into AC power, and a pair of cooling channels across the semiconductor device. The cooling channel may be provided facing only one surface of the semiconductor device.

The power converter 100 of the present embodiment includes the bus bar including an AC bus bar 160 and a DC bus bar 170. The AC bus bar 160 is electrically connected to an AC terminal 121 that is an input and output unit of AC power of the power module 120. The DC bus bar 170 is electrically connected to a DC terminal 122 that is an input and output unit of DC power of the power module 120. The AC bus bar 160 and the AC terminal 121 are disposed facing each other. The DC bus bar 170 and the DC terminal 122 are disposed facing each other. The AC bus bar 160, the DC bus bar 170, the AC terminal 121, and the DC terminal 122 are each formed of a metal plate such as a copper plate bent in an L-shape.

The present embodiment will describe an example of the arc welding device 1, in which the AC terminal 121 or the DC terminal 122 of the power module 120 and the AC bus bar 160 or the DC bus bar 170 are joined by arc welding. That is, the AC terminal 121 or the DC terminal 122, and the AC bus bar 160 or the DC bus bar 170, respectively constitute the first base material 80 and the second base material 90 to be welded by the arc welding device 1.

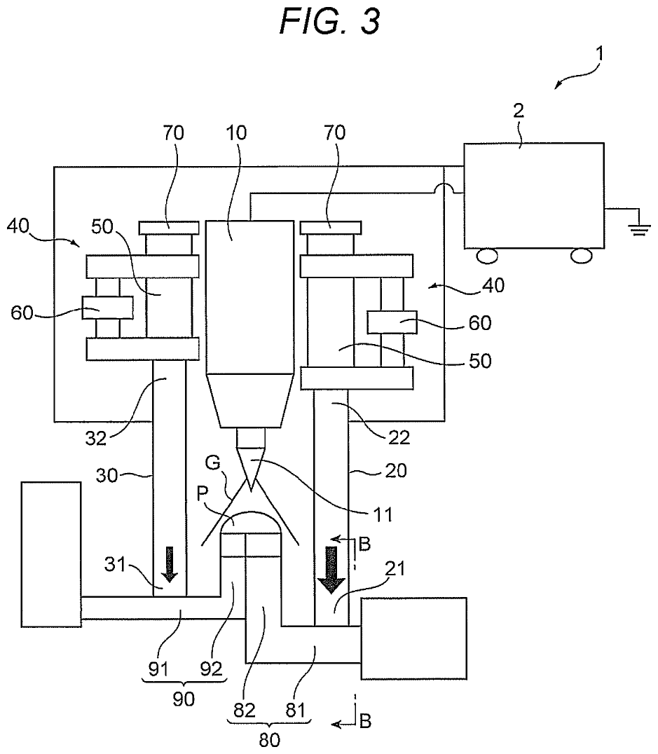

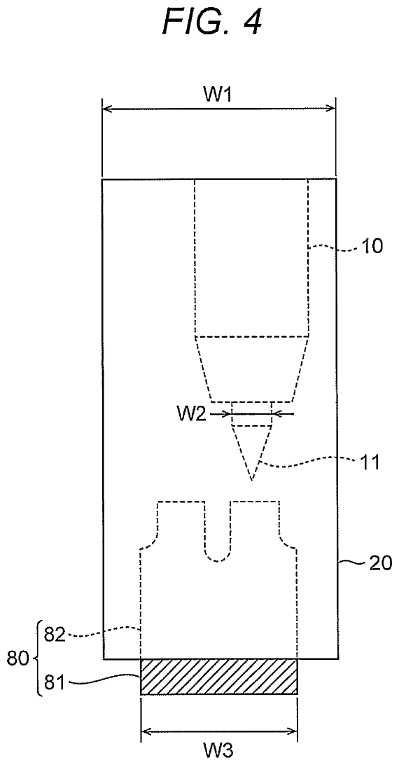

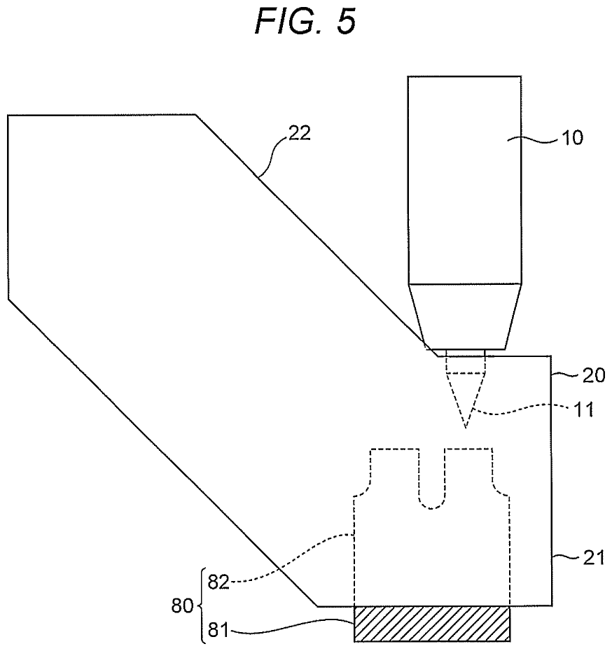

FIG. 3 is a schematic diagram illustrating a configuration of the arc welding device 1 of the present embodiment. FIG. 4 is a schematic sectional diagram taken along line B-B illustrated in FIG. 3. FIG. 5 is a diagram for illustrating another example of a first ground electrode 20 different in shape from that in FIG. 4.

The arc welding device 1 welds the first base material 80 and the second base material 90 that face each other and are in contact with each other. The first base material 80 includes a flat part 81, and a bent part 82 bent from the flat part 81 and extending in an intersecting direction (upward direction) of the flat part 81 toward a welding electrode 11. The second base material 90 includes a flat part 91, and a bent part 92 bent from the flat part 91 and extending in an intersecting direction (upward direction) of the flat part 91 toward the welding electrode 11.

The bent part 82 of the first base material 80 and the bent part 92 of the second base material 90 are in contact with each other. The bent part 82 of the first base material 80 and the bent part 92 of the second base material 90 may extend upward toward the welding electrode 11 from below the welding electrode 11. The bent part 82 of the first base material 80 and the bent part 92 of the second base material 90 are disposed with respective distal end surfaces (upper end surfaces) facing the welding electrode 11 at intervals from the welding electrode 11. The distal end surface of the bent part 82 of the first base material 80 and the distal end surface of the bent part 92 of the second base material 90 are subjected to welding using arc discharge generated between the welding electrode 11 and the distal end surfaces to form a weld P. The distal end surface of the bent part 82 of the first base material 80 and the distal end surface of the bent part 92 of the second base material 90 may be equal in height from a reference surface. The reference surface may be an upper surface of a table or the like on which a device such as the power converter 100 including the first base material 80 and the second base material 90 is placed, or an upper surface of a table or the like on which the first base material 80 and the second base material 90 are placed.

The flat part 81 of the first base material 80 and the flat part 91 of the second base material 90 extend in directions approaching each other. That is, the flat part 81 of the first base material 80 and the flat part 91 of the second base material 90 do not overlap each other when viewed in the direction in which the bent parts 82 and 92 extend, the direction serving as an arrow direction. The flat part 81 of the first base material 80 and the flat part 91 of the second base material 90 may extend along a direction approaching a contact surface between the bent part 82 of the first base material 80 and the bent part 92 of the second base material 90, the direction being orthogonal to the contact surface. The flat part 81 of the first base material 80 and the flat part 91 of the second base material 90 may be different in plate thickness, shape, or the like from each other, and may be different in height from the reference surface from each other, for example.

The arc welding device 1 is a tungsten inert gas (TIG) welding machine, for example. The arc welding device 1 includes a welding torch 10, the first ground electrode 20, a second ground electrode 30, and a pressing mechanism 40.

The welding torch 10 includes a welding electrode 11 that generates arc discharge between the first base material 80 and the second base material 90. The welding electrode 11 is connected to a negative electrode of a welding power supply 2. The welding electrode 11 may be made of tungsten that is less consumed by welding. The welding electrode 11 is disposed facing a contact part between the bent part 82 of the first base material 80 and the bent part 92 of the second base material 90 at an interval. The welding electrode 11 may be disposed facing the distal end surface of the bent part 82 of the first base material 80 and the distal end surface of the bent part 92 of the second base material 90 at an interval. The welding electrode 11 may be disposed downward.

The first ground electrode 20 and the second ground electrode 30 are each connected to a positive electrode of welding power supply 2. The first ground electrode 20 extends along the bent part 82 of the first base material 80 and is formed in a plate shape in contact with the flat part 81 of the first base material 80. The first ground electrode 20 may be formed in a plate shape extending along a direction (downward direction) from the welding electrode 11 toward the bent part 82 of the first base material 80. The second ground electrode 30 extends along the bent part 92 of the second base material 90 and is formed in a plate shape in contact with the flat part 91 of the second base material 90. The second ground electrode 30 may be formed in a plate shape extending along a direction (downward direction) from the welding electrode 11 toward the bent part 92 of the second base material 90. The first ground electrode 20 and the second ground electrode 30 are independently in contact with the flat part 81 of the first base material 80 and the flat part 91 of the second base material 90, respectively.

The first ground electrode 20 and the second ground electrode 30 are disposed away from each other. Between the first ground electrode 20 and the second ground electrode 30, the welding torch 10, the welding electrode 11, the bent part 82 of the first base material 80, and the bent part 92 of the second base material 90 are disposed. The first ground electrode 20 and the second ground electrode 30 are each made of copper or a copper alloy material. The first ground electrode 20 and the second ground electrode 30 each include at least a surface facing the welding electrode 11, the surface being coated with an insulating material.

The first ground electrode 20 includes a distal end part 21 that is in contact with the flat part 81 of the first base material 80. The second ground electrode 30 includes a distal end part 31 that is in contact with the flat part 91 of the second base material 90. The distal end part 21 includes a distal end surface that is in contact with the flat part 81 of the first base material 80 and is parallel to the flat part 81 of the first base material 80. The distal end part 31 includes a distal end surface that is in contact with the flat part 91 of the second base material 90 and is parallel to the flat part 91 of the second base material 90. Each of the distal end surface of the first ground electrode 20 and the distal end surface of the second ground electrode 30 may have a planar shape or a curved surface shape rounded downward.

Although each of the first ground electrode 20 and the second ground electrode 30 may be fixed to a moving mechanism that moves the welding torch 10, the ground electrodes are preferably fixed to a moving mechanism independent of the moving mechanism that moves the welding torch 10.

As illustrated in FIG. 4, the first ground electrode 20 has a dimension W1 in a width direction intersecting (orthogonal to) an extension direction (vertical direction) and a plate thickness direction of the first ground electrode 20, the dimension W1 being larger than a dimension W2 in a width direction of the welding electrode 11. The dimension W1 in the width direction of the first ground electrode 20 may be larger than a dimension W3 in a width direction of the bent part 82 of the first base material 80. Similarly, the second ground electrode 30 has a dimension in the width direction intersecting (orthogonal to) an extension direction (vertical direction) and a plate thickness direction of the second ground electrode 30, the dimension being larger than the dimension W2 in the width direction of the welding electrode 11. The dimension in the width direction of the second ground electrode 30 may be larger than the dimension of the bent part 92 in the width direction of the second base material 90.

The first ground electrode 20 and the second ground electrode 30 having such shapes can surround at least the welding electrode 11. As a result, the first ground electrode 20 and the second ground electrode 30 can shield heat and light generated by arc discharge even in a small work space, and can prevent a heat burn or the like of peripheral components.

Each of the first ground electrode 20 and the second ground electrode 30 may have a wider shape than the welding electrode 11 to be able to shield at least heat and light generated by arc discharge. For example, the first ground electrode 20 may vary in dimension in the width direction from the distal end part 21 to a proximal end part 22, and may have a shape extending obliquely as viewed from the plate thickness direction of the first ground electrode 20, as illustrated in FIG. 5. The same applies to the second ground electrode 30.

The proximal end part 22 of the first ground electrode 20 and a proximal end part 32 of the second ground electrode 30 are each connected to the pressing mechanism 40. The pressing mechanism 40 presses the first ground electrode 20 and the second ground electrode 30 against the flat part 81 of the first base material 80 and the flat part 91 of the second base material 90, respectively, with loads different from each other. The pressing mechanism 40 connected to the first ground electrode 20 and the pressing mechanism 40 connected to the second ground electrode 30 are provided independently of each other. That is, the first ground electrode 20 presses the flat part 81 of the first base material 80 using the pressing mechanism 40. The second ground electrode 30 presses the flat part 91 of the second base material 90 using the pressing mechanism 40. The first ground electrode 20 and the second ground electrode 30 press the flat part 81 of the first base material 80 and the flat part 91 of the second base material 90, respectively, with loads different from each other.

The pressing mechanism 40 includes an absorption mechanism 50, a load detector 60, and a load adjustment mechanism 70.

The absorption mechanism 50 absorbs a difference in height between the flat parts 81 and 91 in the first base material 80 and the second base material 90. The absorption mechanism 50 includes a cylinder that accommodates a spring, for example. The absorption mechanism 50 has a structure capable of exchanging a plurality of types of spring, having different multipliers. The absorption mechanism 50 may be configured with a mechanism without using a spring such as an air cylinder. The absorption mechanism 50 is deformed when the first ground electrode 20 and the second ground electrode 30 press the flat parts 81 and 91, and restored when the pressing is released. The absorption mechanism 50 is insulated from the first ground electrode 20 and the second ground electrode 30. The absorption mechanism 50 connected to the first ground electrode 20 and the absorption mechanism 50 connected to the second ground electrode 30 are provided independently of each other.

The load detector 60 detects a pressing load of the first ground electrode 20 on the flat part 81 of the first base material 80 and a pressing load of the second ground electrode 30 on the flat part 91 of the second base material 90. The load detector 60 includes a pressurizer, for example. The load detector 60 can output a maximum value of the pressing load to a measuring instrument or the like. The load detector 60 is insulated from the first ground electrode 20 and the second ground electrode 30. The load detector 60 that detects the pressing load of the first ground electrode 20 and the load detector 60 that detects the pressing load of the second ground electrode 30 are provided independently of each other.

The load adjustment mechanism 70 adjusts the pressing load of the first ground electrode 20 on the flat part 81 of the first base material 80 and the pressing load of the second ground electrode 30 on the flat part 91 of the second base material 90. The load adjustment mechanism 70 includes a cylinder that accommodates a spring and a screw that extends and contracts the spring, for example. The load adjustment mechanism 70 has a structure capable of exchanging a plurality of types of spring, having different multipliers. The load adjustment mechanism 70 can adjust the pressing load by adjusting the amount of deformation of the spring with the screw. The load adjustment mechanism 70 may be configured with a mechanism without using a spring such as an air cylinder. The load adjustment mechanism 70 is insulated from the first ground electrode 20 and the second ground electrode 30. The load adjustment mechanism 70 that adjusts the pressing load of the first ground electrode 20 and the load adjustment mechanism 70 that adjusts the pressing load of the second ground electrode 30 are provided independently of each other.

FIG. 3 illustrates the first base material 80 and the second base material 90 that are different in plate thickness, different in length of the flat parts 81 and 91, and different in height of the flat parts 81 and 91 from the reference surface. That is, the first base material 80 is different in rigidity from the second base material 90. FIG. 3 illustrates the first base material 80 that has a larger plate thickness than the second base material 90. The flat part 91 of the second base material 90 has a longer length than the flat part 81 of the first base material 80. The flat part 91 of the second base material 90 has a higher height than the flat part 81 of the first base material 80. In this case, the load adjustment mechanism 70 causes the first ground electrode 20 to have a larger pressing load than the second ground electrode 30. As a result, the load adjustment mechanism 70 can adjust each pressing load to cause the flat parts 81 and 91 of the first base material 80 and the second base material 90 to be equal in the amount of deflection, thereby causing the bent parts 82 and 92 to be equal in the amount of displacement.

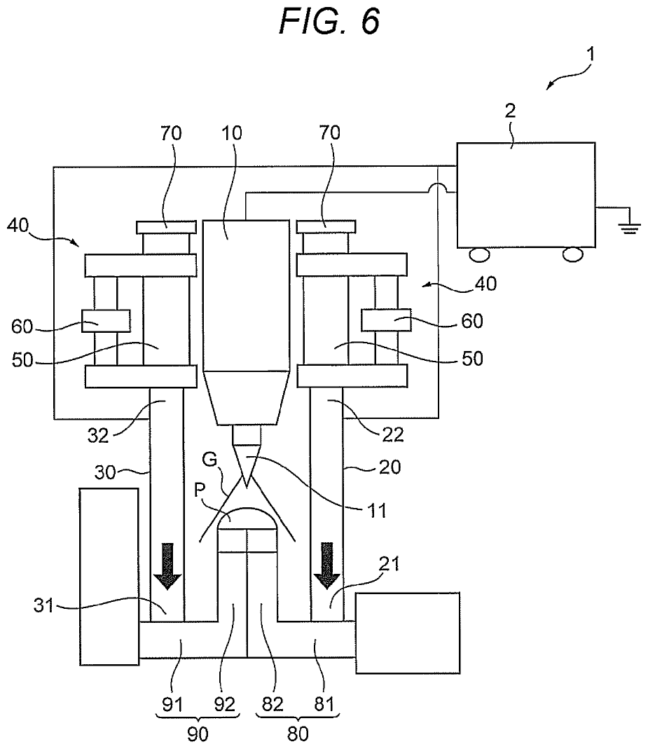

FIG. 6 is a diagram for illustrating operation of the load adjustment mechanism 70 when the first base material 80 and the second base material 90 are identical in shape.

FIG. 6 illustrates the first base material 80 and the second base material 90 that are equal in plate thickness, equal in length of the flat parts 81 and 91, and equal in height of the flat parts 81 and 91 from the reference surface. That is, the first base material 80 is equal in rigidity to the second base material 90. In this case, the load adjustment mechanism 70 causes the first ground electrode 20 and the second ground electrode 30 to have an equal pressing load. As a result, the load adjustment mechanism 70 can adjust each pressing load to cause the flat parts 81 and 91 of the first base material 80 and the second base material 90 to be equal in the amount of deflection, thereby causing the bent parts 82 and 92 to be equal in the amount of displacement.

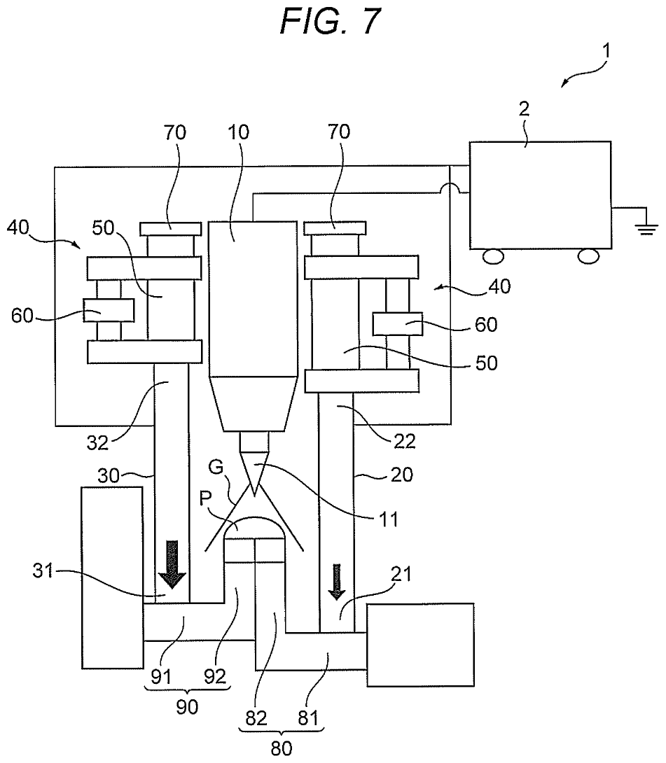

FIG. 7 is a diagram for illustrating operation of the load adjustment mechanism 70 when the first base material 80 and the second base material 90 are different in shape.

FIG. 7 illustrates the first base material 80 and the second base material 90 that are equal in plate thickness, equal in length of the flat parts 81 and 91, and different in height of the flat parts 81 and 91 from the reference surface. That is, the first base material 80 is different in rigidity from the second base material 90. FIG. 7 illustrates the flat part 91 of the second base material 90, having a higher height than the flat part 81 of the first base material 80. That is, the bent part 92 of the second base material 90 also has a shorter length than the bent part 82 of the first base material 80. In this case, the load adjustment mechanism 70 causes the second ground electrode 30 to have a larger pressing load than the first ground electrode 20. As a result, the load adjustment mechanism 70 can adjust each pressing load to cause the flat part 91 of the second base material 90 to have a larger amount of deflection than the flat part 81 of the first base material 80, thereby causing the bent parts 82 and 92 of the first base material 80 and the second base material 90 to be equal in the amount of displacement. FIG. 7 illustrates the load adjustment mechanism 70 that may apply a pressing load to the second ground electrode 30, the pressing load being set to equal to a pressing load to the first ground electrode 20, as long as the bent parts 82 and 92 of the first base material 80 and the second base material 90 are not greatly different in the amount of displacement.

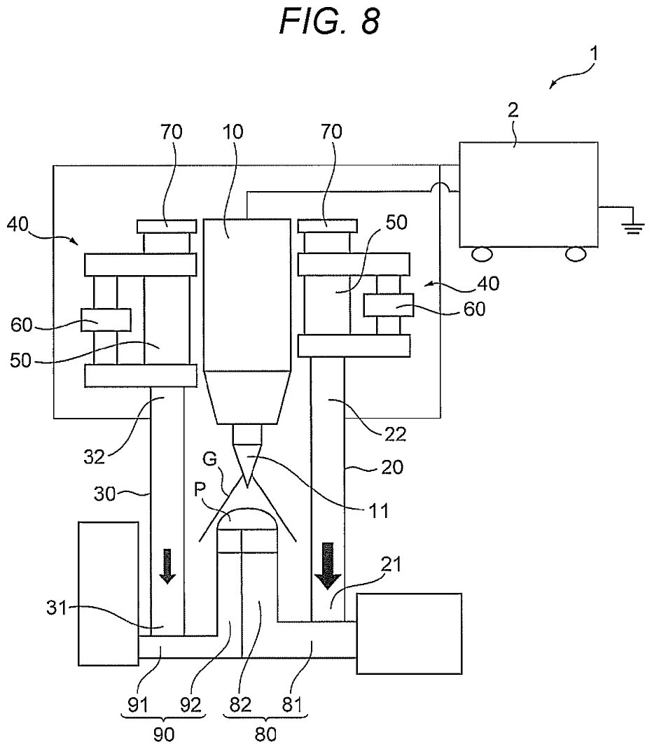

FIG. 8 is a diagram for illustrating operation of the load adjustment mechanism 70 when the first base material 80 and the second base material 90 are different in shape.

FIG. 8 illustrates the first base material 80 and the second base material 90 that are different in plate thickness, equal in length of the flat parts 81 and 91, and equal in height of the flat parts 81 and 91 from the reference surface. That is, the first base material 80 is different in rigidity from the second base material 90. FIG. 8 illustrates the first base material 80 that has a larger plate thickness than the second base material 90. In this case, the load adjustment mechanism 70 causes the first ground electrode 20 to have a larger pressing load than the second ground electrode 30. As a result, the load adjustment mechanism 70 can adjust each pressing load to cause the flat parts 81 and 91 of the first base material 80 and the second base material 90 to be equal in the amount of deflection, thereby causing the bent parts 82 and 92 to be equal in the amount of displacement.

Next, a procedure of welding work performed by the arc welding device 1 will be described with reference to FIG. 3. The arc welding device 1 moves the first ground electrode 20 and the second ground electrode 30 to be respectively brought into contact with the flat part 81 of the first base material 80 and the flat part 91 of the second base material 90. FIG. 3 illustrates the load adjustment mechanism 70 that adjusts the pressing load of the first ground electrode 20 to be larger than the pressing load of the second ground electrode 30 as described above. The arc welding device 1 checks whether a load value is within a management range using the load detector 60 that detects the load value adjusted by the load adjustment mechanism 70 while the spring constituting the absorption mechanism 50 is deformed. The arc welding device 1 then moves the welding torch 10 to a position suitable for welding. Alternatively, the first ground electrode 20 and the second ground electrode 30, and the welding torch 10 may be fixed to a single moving mechanism.

Subsequently, the arc welding device 1 selects welding conditions suitable for the first base material 80 and the second base material 90, and applies a welding current to a space among the first base material 80 and the second base material 90 that are respectively in contact with the first ground electrode 20 and the second ground electrode 30, and the welding electrode 11. At this time, the arc welding device 1 blows a shielding gas G from the welding torch 10 to the bent part 82 of the first base material 80 and the bent part 92 of the second base material 90. The shielding gas G is an inert gas such as argon gas, and shields the bent part 82 and the bent part 92 from the atmosphere to prevent oxidation.

Arc discharge occurs in the space among the distal end surface of the bent part 82 of the first base material 80 and the distal end surface of the bent part 92 of the second base material 90, and the welding electrode 11. The weld P in a hemispherical shape is formed covering both the distal end surface of the bent part 82 of the first base material 80 and the distal end surface of the bent part 92 of the second base material 90. Forming the weld P in a hemispherical shape enables the arc welding device 1 to increase a contact area of the weld P with the first base material 80 and the second base material 90, so that welding strength can be increased. Additionally, forming the weld P in a hemispherical shape enables the arc welding device 1 to facilitate visual inspection whether the first base material 80 and the second base material 90 are satisfactorily welded. That is, forming the weld P in a hemispherical shape enables the arc welding device 1 to easily ensure necessary welding quality.

After that, the arc welding device 1 cuts off the welding current to release the pressing of the first ground electrode 20 and the second ground electrode 30, thereby separating the ground electrodes from the first base material 80 and the second base material 90. The arc welding device 1 then separates the welding torch 10 from the first base material 80 and the second base material 90. This completes the welding work of the arc welding device 1.

As described above, the arc welding device 1 of the present embodiment welds the first base material 80 and the second base material 90 that respectively include the flat parts 81 and 91, and the bent parts 82 and 92, the flat parts 81 and 91 extending in a direction of approaching each other, and the bent parts 82 and 92 being bent from the flat parts 81 and 91, respectively, and extending in an intersecting direction of the flat parts 81 and 91 while being in contact with each other. The arc welding device 1 includes the welding electrode 11 disposed facing a contact part between the bent part 82 of the first base material 80 and the bent part 92 of the second base material 90, the first ground electrode 20 extending along the bent part 82 of the first base material 80 while being in contact with the flat part 81 of the first base material 80, and the second ground electrode 30 extending along the bent part 92 of the second base material 90 while being in contact with the flat part 91 of the second base material 90. The first ground electrode 20 and the second ground electrode 30 are independently in contact with the flat part 81 of the first base material 80 and the flat part 91 of the second base material 90, respectively.

This configuration enables the arc welding device 1 to easily ground the first ground electrode 20 and the second ground electrode 30 by simply moving not only the first ground electrode 20 along an extension direction of the first ground electrode 20 but also the second ground electrode 30 along an extension direction of the second ground electrode 30. That is, the arc welding device 1 does not require an opening and closing space of a chuck mechanism as in conventional devices, which is configured to hold the bent part 82 of the first base material 80 and the bent part 92 of the second base material 90 from a direction in which the first base material 80 and the second base material 90 face each other and ground the materials. Thus, the arc welding device 1 can perform welding work even in a small work space.

The arc welding device 1 also enables the first ground electrode 20 and the second ground electrode 30 to be independently in contact with the flat part 81 of the first base material 80 and the flat part 91 of the second base material 90, respectively. As a result, even when the first base material 80 and the second base material 90 are different in plate thickness, shape, or the like, the arc welding device 1 enables the base materials to be grounded by appropriate bringing the first ground electrode 20 and the second ground electrode 30 into contact with the flat parts 81 and 91, respectively, in accordance with the plate thicknesses, shapes, or the like of the first base material 80 and the second base material 90. Thus, the arc welding device 1 can prevent welding quality from deteriorating due to unstable arc discharge because the welding current does not stably flow due to grounding failure.

The arc welding device 1 also enables grounding by bringing the first ground electrode 20 and the second ground electrode 30 into contact with the flat parts 81 and 91 separated from the distal end surfaces of the bent parts 82 and 92, respectively, without contact with the distal end surfaces that are to be welded. As a result, the arc welding device 1 can form the weld P in a hemispherical shape covering the distal end surfaces of the bent parts 82 and 92. Thus, the arc welding device 1 can increase a contact area of the weld P with the first base material 80 and the second base material 90, so that welding strength can be increased. Additionally, the arc welding device 1 can facilitate visual inspection whether the first base material 80 and the second base material 90 are satisfactorily welded. Thus, the arc welding device 1 can easily ensure necessary welding quality.

As a result, the arc welding device 1 of the present embodiment enables the base materials 80 and 90 different in plate thickness, shape, or the like to be welded with high quality in a small work space.

The arc welding device 1 of the present embodiment further includes the pressing mechanism 40 that is connected to the first ground electrode 20 and the second ground electrode 30 and presses the first ground electrode 20 and the second ground electrode 30 against the flat part 81 of the first base material 80 and the flat part 91 of the second base material 90, respectively, with loads different from each other.

As a result, even when the first base material 80 and the second base material 90 are different in rigidity from each other due to a difference in plate thickness, shape, or the like between the first base material 80 and the second base material 90, the arc welding device 1 can appropriately press the first ground electrode 20 and the second ground electrode 30 against the flat parts 81 and 91, respectively, in accordance with the rigidity of each of the first base material 80 and the second base material 90. Thus, the arc welding device 1 can reliably bring the first ground electrode 20 and the second ground electrode 30 into contact with the flat parts 81 and 91, respectively, and can suppress excessive deformation of one of the first base material 80 and the second base material 90. As a result, the arc welding device 1 can prevent welding quality from deteriorating because the welding current does not stably flow due to grounding failure or an attitude suitable for welding of the bent parts 82 and 92 cannot be ensured. Additionally, the arc welding device 1 can suppress excessive deformation of the first base material 80 and the second base material 90, so that restriction on shape or material of the first base material 80 and the second base material 90 can be reliably alleviated. Thus, the arc welding device 1 of the present embodiment enables the base materials 80 and 90 different in plate thickness, shape, or the like to be welded with high quality in a small work space.

The arc welding device 1 of the present embodiment uses the flat part 81 of the first base material 80 and the flat part 91 of the second base material 90 that are different in height from the reference surface, and includes the pressing mechanism 40 provided with the absorption mechanism 50 that is connected to the first ground electrode 20 and the second ground electrode 30 to absorb a difference in height between the flat parts 81 and 91 of the first base material 80 and the second base material 90.

As a result, the arc welding device 1 enables the first ground electrode 20 and the second ground electrode 30 to be reliably brought into contact with the flat parts 81 and 91, respectively, even when the flat parts 81 and 91 are different in height in design or the flat parts 81 and 91 are different in height due to variations in assembly tolerance of the power converter 100 or the like. Thus, the arc welding device 1 can prevent welding quality from deteriorating due to unstable arc discharge because the welding current does not stably flow due to grounding failure. Thus, the arc welding device 1 of the present embodiment enables the base materials 80 and 90 different in plate thickness, shape, or the like to be welded with high quality in a small work space.

The pressing mechanism 40 in the arc welding device 1 of the present embodiment further includes the load detector 60 that detects a pressing load of the first ground electrode 20 against the flat part 81 of the first base material 80 and a pressing load of the second ground electrode 30 against the flat part 91 of the second base material 90.

This configuration enables the arc welding device 1 to monitor whether the first ground electrode 20 and the second ground electrode have a contact failure with the flat parts 81 and 91. Thus, the arc welding device 1 can prevent welding quality from deteriorating due to grounding failure caused by contact failure between the first ground electrode 20 and the second ground electrode 30. Thus, the arc welding device 1 of the present embodiment enables the base materials 80 and 90 different in plate thickness, shape, or the like to be welded with high quality in a small work space.

The pressing mechanism 40 in the arc welding device 1 of the present embodiment further includes the load adjustment mechanism 70 that adjusts a pressing load of the first ground electrode 20 against the flat part 81 of the first base material 80 and a pressing load of the second ground electrode 30 against the flat part 91 of the second base material 90.

This configuration enables the arc welding device 1 not only to stably perform arc discharge by preventing grounding failure, but also to ensure an attitude suitable for welding of each of the bent parts 82 and 92, so that necessary welding quality can be reliably ensured.

Additionally, the arc welding device 1 can suppress excessive deformation of the first base material 80 and the second base material 90, so that restriction on shape or material of the first base material 80 and the second base material 90 can be reliably alleviated. Thus, the arc welding device 1 of the present embodiment enables the base materials 80 and 90 different in plate thickness, shape, or the like to be welded with high quality in a small work space.

The first ground electrode 20 in the arc welding device 1 of the present embodiment has a dimension in the width direction intersecting the extension direction and the plate thickness direction of the first ground electrode 20, the dimension being larger than a dimension in the width direction of the welding electrode 11. The second ground electrode 30 therein has a dimension in the width direction intersecting the extension direction and the plate thickness direction of the second ground electrode 30, the dimension being larger than the dimension in the width direction of the welding electrode 11. The first ground electrode 20 and the second ground electrode 30 surround the welding electrode 11.

This configuration enables the first ground electrode 20 and the second ground electrode 30 in the arc welding device 1 to shield heat and light generated by arc discharge even in a small work space. Thus, the arc welding device 1 does not require a burn prevention member to be separately installed, the burn member having prevention been conventionally required, so that a heat burn or the like of peripheral components can be prevented even in a small work space. As a result, the arc welding device 1 of the present embodiment can prevent a heat burn or the like of the peripheral components while welding the base materials 80 and 90 different in plate thickness, shape, or the like with high quality in a small work space.

The present invention is not limited to the above embodiment, and includes various modifications. For example, the above embodiments have been described in detail to describe the present invention in an easy-to-understand manner, and are not necessarily limited to those having all the described configurations. The configuration of any one of the embodiments can be partially replaced with a configuration of another embodiment, and the configuration of the other embodiment can be added to the configuration of any one of the embodiments. Additionally, another configuration can be added, deleted, and replaced for a part of the configuration of each embodiment.

### REFERENCE SIGNS LIST

1 arc welding device
11 welding electrode
20 first ground electrode
30 second ground electrode
40 pressing mechanism
50 absorption mechanism
60 load detector
70 load adjustment mechanism
80 first base material
81 flat part
82 bent part
90 second base material
91 flat part
92 bent part

1. An arc welding device configured to weld a first base material and a second base material and respectively including flat parts and bent parts, the flat parts extending in a direction of approaching each other, and the bent parts being bent from the corresponding flat parts and extending in an intersecting direction of the flat parts to be in contact with each other,
the arc welding device comprising:
a welding electrode disposed facing a contact part between the bent part of the first base material and the bent part of the second base material;
a first ground electrode extending along the bent part of the first base material to be in contact with the flat part of the first base material; and
a second ground electrode extending along the bent part of the second base material to be in contact with the flat part of the second base material,
the first ground electrode and the second ground electrode being respectively in contact with the flat part of the first base material and the flat part of the second base material independently of each other.

2. The arc welding device according to claim 1, further comprising
a pressing mechanism that is connected to the first ground electrode and the second ground electrode and presses the first ground electrode and the second ground electrode against the flat part of the first base material and the flat part of the second base material, respectively, with loads different from each other.

3. The arc welding device according to claim 2, wherein
the flat part of the first base material and the flat part of the second base material are different in height from a reference surface, and
the pressing mechanism includes an absorption mechanism that absorbs a difference in height between the flat parts of the first base material and the second base material.

4. The arc welding device according to claim 2, wherein the pressing mechanism includes a load detector that detects a pressing load of the first ground electrode against the flat part of the first base material and a pressing load of the second ground electrode against the flat part of the second base material.

5. The arc welding device according to claim 2, wherein the pressing mechanism includes a load adjustment mechanism that adjusts a pressing load of the first ground electrode against the flat part of the first base material and a pressing load of the second ground electrode against the flat part of the second base material.

6. The arc welding device according to claim 1, wherein
the first ground electrode has a dimension in a width direction intersecting an extension direction and a plate thickness direction of the first ground electrode, the dimension being larger than a dimension of the welding electrode in the width direction,
the second ground electrode has a dimension in a width direction intersecting an extension direction and a plate thickness direction of the second ground electrode, the dimension being larger than the dimension of the welding electrode in the width direction, and
the first ground electrode and the second ground electrode surround the welding electrode.
